(19) United States
(12) Patent Application Publication
(10) Pub. No.: US 2025/0007744 A1
(43) Pub. Date: Jan. 2, 2025

(54) IMPROVED ROUTING FOR TRICKLE ALGORITHM

(71) Applicant: SEMITECH SEMICONDUCTOR PTY LTD, Tustin, CA (US)

(72) Inventors: Ushan KAUNATHILAKA, Doreen (AU); Sverrir OLAFSSON, Reykjavik (IS)

(21) Appl. No.: 18/695,445

(22) PCT Filed: Sep. 28, 2022
(86) PCT No.: PCT/US2022/045115

§ 371 Date: Mar. 26, 2024

Related U.S. Application Data
(60) Provisional application No. 63/249,044, filed on Sep. 28, 2021.

(51) Int. Cl. H04L 12/18; H04L 43/16

(52) U.S. Cl. CPC H04L 12/1886; H04L 12/1868; H04L 12/1881; H04L 43/16

(57) ABSTRACT

The present invention provides an improved routing method for Trickle algorithm. The Trickle Algorithm is used to reduce traffic congestion where each node holds off retransmission for a random period of time and while waiting, it listens for other retransmissions and if multiple similar transmissions are detected, the node then omits the retransmission altogether. However, in certain cases, where individual nodes are critical to connecting parts of the network, connectivity may be lost when they decide not to forward the broadcast packets they receive. The present invention provides the solution to this problem by use of unicast routing information present in the nodes. All the nodes in the network track the frequency of forwarding unicast packets that can be used to calculate a metric. The metric is used to alter the trickle algorithm to increase the likelihood that broadcast packets are forwarded from one portion of the network to another.

### CROSS-REFERENCE TO RELATED APPLICATIONS

This application claims benefit to U.S. Provisional Patent Application 63/249,044 filed Sep. 28, 2021, the disclosures of which are hereby incorporated by reference in their entirety.

### FIELD OF THE INVENTION

The present invention relates to field of communication in a mesh network and more particularly, to a routing algorithm in a mesh network.

### BACKGROUND OF THE INVENTION

Mesh networks are often used in both wireless and wired networks where communication reach is limited, and each node is not able to communicate directly with some of the other nodes in the network.

There are many different strategies to determine how to forward packets to ensure full connectivity. It can be assigned manually when the nodes are deployed, by simply assigning routing tables based on testing the connections when the nodes are installed. The routing tables can also be assigned automatically with different strategies. For example, in some networks a coordinator or base node will manage the network routing by establishing connectivity and routing tables when a node joins the network, often with hierarchical structures being formed. In others, the routing strategy is developed autonomously, where each node probes the surrounding network and other nodes assist in finding a route to a distant node. Some examples of routing algorithms are LOADng and RPL.

Independent of how the network is formed, mesh networks typically maintain two types of tables, neighbor tables and routing tables. Neighbor tables track nodes that are reachable directly, and contain information on modulation modes to use, connection quality and other useful information needed to maintain and monitor the reliability of the connection. On the other hand, routing tables store information needed to reach remote nodes that are not reachable directly. For a given connection, all that is needed is which node is the first one on the route to the remote node. If each node on the path has that information, the route is valid. For example, if A needs to be routed through B and then C to get to D, all A needs to know is that B is the first node on the route to D. If then B knows that C is the first node on its route to D, it will forward packets going from A to D through C.

When broadcast packets are transmitted in mesh networks, the network may become congested. In legacy mesh networks each node will retransmit broadcast packets after a suitable and typically random waiting period. If not all nodes retransmit broadcast packets, chances are that some nodes in the network will not receive the broadcast at all. To limit redundant traffic each node typically ensures that it only rebroadcasts once, but if many nodes are in a cluster (where all nodes can communicate with each other) there can be severe congestion.

The Trickle Algorithm (RFC 6206) aims to reduce this congestion without losing any connectivity. When a node receives a broadcast packet, it starts a process to determine whether to retransmit the packet. During that process it detects retransmissions from other nodes. If those packets seem to be coming from nodes close to the receiving node, it may infer that its own retransmission would have a similar reach as the packet already transmitted, and declare it “consistent”. After receiving multiple such consistent packets it may then conclude there is no point in it retransmitting, as its neighbors have already reached the relevant nodes. The trickle algorithm formalizes the waiting times and packet counts and by managing those parameters the network efficiency can be greatly improved.

Consider, however, the case where there are two clusters of nodes, cluster A and cluster B, where all nodes in cluster A can communicate with each other directly, and all nodes in cluster B can communicate with each other directly. Further assume that some nodes belong to both clusters (intersection of A and B, ANB) and other nodes are not able to communicate directly with the other cluster. Namely, if a packet is to be forwarded from cluster A to cluster B, it must get forwarded by a node in A∩B (or originate from one). In typical trickle implementations, if a broadcast packet is sent in cluster A, all nodes in A will select a random timer, during which they listen for retransmissions and if a certain number is detected, they will not retransmit the packet. If enough nodes in A but outside A∩B retransmit a packet, none of the nodes in A∩B will forward the packet and it will not be received by nodes in B (outside of A∩B). Hence the algorithm will commonly fail to forward the broadcast packets.

A cluster of nodes is generally defined as nodes in close proximity. But in the context of trickle implementations it is determined based on the definition of “consistent” packets, which is often based on a quality measure such as SNR (Line Quality Indicator or LQI) and/or RSSI (Received Signal Strength). Namely, if retransmitted packets are received with a quality measure LQI greater than a threshold, it can be considered as coming from a node in the same cluster. One drawback of such measures is what could be called LQI saturation. If the signals being transmitted have limited EVM (Error Vector Magnitude), i.e. the SNR in the transmit signal itself, a receiving modem will not be able to distinguish SNR environments slightly above the EVM from those significantly above it. As an example, if the EVM of all transmit signals is 20 dB and they are transmitted at 0 dBm, a receiving node with a noise level of −20 dBm will compute a similar LQI to a node with a noise level of −60 dBm. Alternately, two nodes with a noise level of −60 dBm but with 40 dB attenuation between them will compute a similar LQI value for a packet transmitted at OdBm with 20 dB EVM and consider themselves in the same cluster. Thus the “consistency” criteria can make the abovementioned broadcast failure a common occurrence.

In light of the foregoing discussion, an improved algorithm for reducing redundant transmission in mesh network is needed that utilizes Trickle algorithm for reducing redundant transmission while eliminating the risk of abject failure of broadcasting.

### SUMMARY

In an aspect of present invention, a method to improve network penetration of broadcast traffic that is managed by a trickle algorithm or a variant thereof in a mesh network is provided. The method comprising: determining the role of a node in routing a packet in a unicast transmission and calculating a metric for a routing status of the node in the unicast transmission by collecting information about the node's role in forwarding the unicast packet; calculating a routable index for the node to determine if the node has previously routed a packet from the broadcast originator, if the node is configured as a router statically and if the node acted as router for other nodes; calculating a transmit time for the node in Trickle algorithm using the routable index; calculating a redundancy constant for the node in the Trickle algorithm using the routable index; applying the transmit time and the redundancy constant in the Trickle algorithm to broadcast the message through the node. The method further comprising determining a link metric to select a node to broadcast the message. In the method, the node having higher redundancy constant compared to other node, will broadcast the message. In a mesh routing system using the trickle algorithm based on a metric calculated using RSSI and SNR/LQI for retransmission of broadcast packets including an algorithm for routing unicast packets, modifying the trickle algorithm to include parameters from said unicast routing algorithm to improve probability of packets being forwarded from one network cluster to another. The method comprises assessing whether the node is designated as part of a constructed route for unicast packets between two other nodes.

In the method, the redundancy constant is modified based on unicast routing metrics. The unicast routing status is comprised of at least static configuration of the node as a router

The unicast routing status is comprised of at least the number of times the node has forwarded unicast packets or at least the number of times the node has forwarded unicast packets from the broadcast originator or at least static configuration and the number of times the node has forwarded unicast packets from the broadcast originator. In the method, the decision of transmission time is also based on LQI/SNR or RSSI or both.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 is a schematic arrangement showing broadcasting in a mesh network with a plurality of nodes in accordance with an embodiment of the present invention.

FIG. 2 illustrates broadcast at each node in Trickle algorithm, in accordance with an embodiment of the present invention.

FIG. 3 is a flow diagram showing broadcast in a mesh network that utilizes routable index, in accordance with an embodiment of the present invention.

### DETAILED DESCRIPTION OF THE INVENTION

In the following detailed description of embodiments of the invention, numerous specific details are set forth in order to provide a thorough understanding of the embodiments of the invention. However, it will be obvious to a person skilled in the art that the embodiments of the invention may be practiced without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variation, substitutions and equivalents will be apparent to those skilled in the art without parting from the spirit and scope of the invention.

The present invention provides an improved method for broadcasting a message in a mesh network by utilizing unicast routing information present in the nodes for improving transmission in Trickle Algorithm.

The Trickle Algorithm can greatly reduce redundant retransmissions in mesh networks. There are scenarios where certain nodes are essential to forwarding broadcast packets throughout the network. If those essential nodes decide not to retransmit the broadcast packets they receive, segments of the network may not receive those broadcasts at all. According to this invention, in addition to the traditional Trickle Algorithm, the node will consider the parameters of its unicast routing information and take those into consideration when deciding whether to re-transmit the packet. In effect, the node will realize its retransmissions are critical to forwarding packets in the network and retransmit accordingly. This will guarantee network penetration without flooding the network.

In mesh networks, routing for unicast packets typically follows different rules than for broadcast packets. Thus, usually a specific algorithm is used to construct a route from one node to another, where each node records the first node on the route towards each other node it needs to communicate with. In the case above, unicast traffic between nodes in clusters A and B will typically be routed through nodes in A∩B without any issue. If all the nodes in the network tracked the frequency of when they are called on to forward unicast packets, a measure of how important they are for routing between segments of the network could be calculated. In the present invention, such a metric is calculated and used to alter the trickle algorithm to greatly increase the likelihood that broadcast packets will be forwarded from one portion of the network to another.

The routing status of a node is the collection of information gathered about the node's role in forwarding unicast packets. It may also include static configuration, if a node is manually configured as a router.

Typically mesh networks employ a specific method to establish routing between any two nodes. A node A may initiate a route establishment for a route to node B by transmitting a broadcast packet asking other nodes if they have a route to node B. Depending on the routing algorithm, the result of the route establishment is for node A to identify the node C which shall be the first hop on the route from A to B.

During the route establishment, if a node receiving the route request to B, does not have a route to node B it will simply rebroadcast the route request. If it does have a route to B, it will generate a response to the route request that will support establishing the most efficient route from A to B. In LOADng, this involves forwarding the route-request as a unicast packet to B. B will then compare the valid routes it receives and transmit the most efficient route to A as a unicast packet.

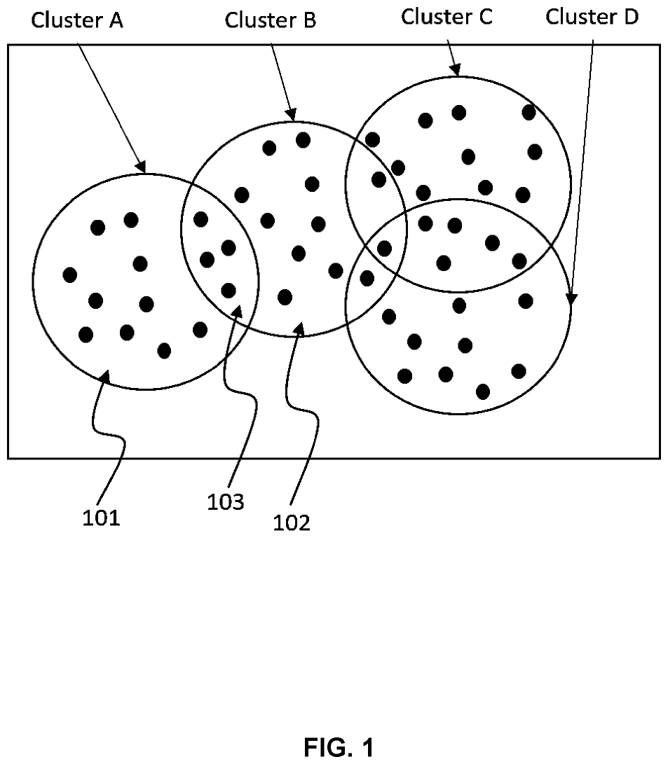

FIG. 1 is a schematic arrangement showing broadcasting in a mesh network with a plurality of nodes in accordance with an embodiment of the present invention. The mesh network in FIG. 1 shows nodes in cluster A 101, cluster B 102, cluster C and cluster D. The nodes in cluster A are in direct communication to nodes in ANB 103. For broadcasting a message, nodes in A∩B are essential for transmitting message from cluster A to cluster B. To facilitate connections where the communicating nodes cannot reach each other directly, other nodes between the two will forward packets between them.

For example, if A and C want to communicate but are not able to send packets to each other directly, there may be a node B between them that can communicate with them both. Thus, for A to send a packet to C, it can send the packet to B and then based on information in the packet header, B will forward to C by retransmitting it. Similarly for C to send a packet to A, it will send it to B who will forward to A. This can then extend to multiple levels, where multiple nodes may be required to forward the packet between two nodes.

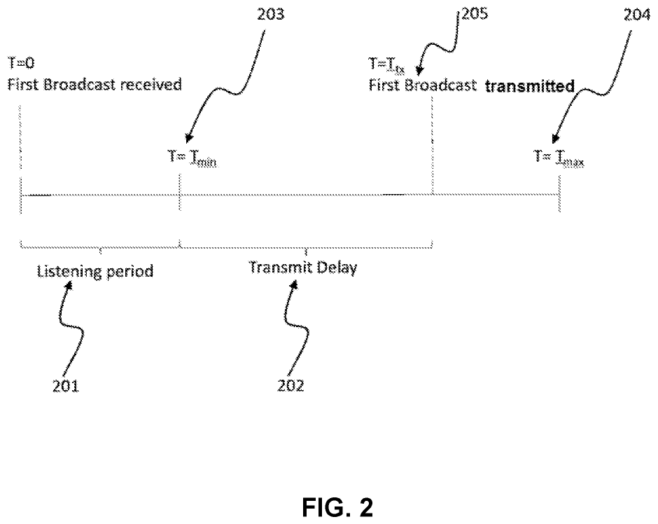

FIG. 2 illustrates broadcast at each node in Trickle algorithm, in accordance with an embodiment of the present invention. Trickle timer runs for a defined interval and has three configuration parameters: the minimum interval size Tmin 203, the maximum interval size Tmax 204, listening period 201, transmit delay 202 and a redundancy constant k. The minimum interval size, Tmin, is defined in units of time. For example, a protocol might define the minimum interval as 100 milliseconds. The maximum interval size, Tmax, is often described as a number of doublings of the minimum interval size. The redundancy constant, k, is a natural number (an integer greater than zero). In addition to these three parameters, Trickle maintains three variables: I, the current interval size; t, a time within the current interval; and c, a counter.

When the algorithm starts execution, it sets I to a value in the range of [Tmin, Tmax]—that is, greater than or equal to T min and less than or equal to Tmax. The algorithm then begins the first interval. When an interval begins, Trickle resets c to 0 and sets t to a random point in the interval, taken from the range [I/2, I), that is, values greater than or equal to I/2 and less than I. The interval ends at I. Whenever Trickle hears a transmission 205 that is “consistent”, it increments the counter c. At time t, Trickle transmits if and only if the counter c is less than the redundancy constant k. When the interval I expires, Trickle doubles the interval length. If this new interval length would be longer than the time specified by Tmax, Trickle sets the interval length I to be the time specified by Tmax. If Trickle hears a transmission that is “inconsistent” and I is greater than Tmin, it resets the Trickle timer. To reset the timer, Trickle sets I to Tmin and starts a new interval. If I is equal to Tmin when Trickle hears an “inconsistent” transmission, Trickle does nothing. Trickle can also reset its timer in response to external “events”

In an embodiment, the present invention provides a new metric (Routable Index-Ri) that is introduced to measure the significance of a node in forwarding a packet. It considers whether the node has previously routed a packet from the broadcast originator, whether it is configures a router statically and whether it is acting as a router for any node. This metric can be used to tune the parameters of the trickle algorithm to improve probability of penetrating the packet through multiple hops. In the following example, one way to calculate such a metric is demonstrated.

$$Ri ( Routable Index ) = Kn * rn + Ks * r + Kd * \frac{T - t}{T}$$

r—Some nodes are configured as routers by default. For example, full functions devices always act as routers in wireless mesh networks
   1: if a node is statically configured as a router
   0: if a node is not statically configured as a router
rn—Whether the node has acted as a router for the originator of the broadcast packet
   1: Node acts as a router for the originator
   0: Node does not act as a router for the originator
“rn” is updated by the routing algorithm. Typically the routing table contains a routing tuple containing the destination and the next hop address. Rn is set to 1 for a particular destination if the routing algorithm establishes a route to that destination where a different node initiates the route establishment. “Rn” is a flag in in the routing table entry for destination. This flag indicates that the node acts as a router on behalf of some other node's route establishment process.
   Kn—Specific node router weight
   T—Maximum unicast idle period in network time units
   t—time since last routed unicast in network time units.
   Ks—Static Router weight
   Kd—Any node Router weight

Nodes with higher Routable Index should rebroadcast the message earlier than the nodes with lower Routable Index. This is used to determine the re-broadcast scheduling time with respect to the first message received. The trickle algorithm or its variant, uses a random time interval that lies between minimum and maximum intervals to re-broadcast. This rebroadcast window starts after a fixed listening period. This is illustrated in the FIG. 2.

This random interval is replaced by a calculated value based on Routable Index. Higher Routable index will generate a lower transmit time 202. Transmit Time is a function of Routable Index.

Transmit time=f(Ri)

### Use Link Metric to Further Select the Node to Rebroadcast

Some routing algorithms may install routes within the same cluster. As a result of that, those are selected as higher probable candidates to rebroadcast. Link metric, such as RSSI or LQI, of the received similar or consistent broadcast messages can be used to further qualify the possible candidate. A node that receives a lower link metric should rebroadcast earlier as those are located at the edge of the cluster compared to previous hop. As a result of this, transmit time is considered as a function of Routable index and Link Metric.

Transmit time=f(Ri,Minimum Link Metric)

### Routers Use Higher Redundancy Constant

The redundancy constant is a threshold that determines whether or not there are enough broadcast messages in the cluster to suppress the further forward. Nodes with a higher Routable Index can use a higher redundancy constant so that they get a higher chance to get selected to forward the broadcast packet.

Redandancy constant=g(Ri)

### Use Link Metric to Determine Consistant Transmit

Usually received messages are considered “consistent” with a previously received broadcast message, if the originator and the message sequence number are identical to the buffered message. Present inventions say it can be “optionally” marked as a “consistent” if a link metric is higher than a configured threshold.

Consistancy=h([Broadcast originator,message sequenc number],[buffered originator,buffered sequence numebr],Received mink metric)

### Combined Algorithms

The present invention suggests any function to determine Transmit time and Redundancy constant without breaking the mentioned relationships. As examples but not limited to, Example 1:
If the node has forwarded unicast packets from node A before, then upon receiving a broadcast packet from node A, it will forward the packet and ignore the trickle algorithm.

### Example 2

Transmit time=f(Ri) Where higherRi shold gnerate Higher Transmit time

Assign Transmit time Linearly according to the above relationship,

$$Transmit time = \frac{T min - T max}{Maximum possible Ri} * Ri + T max - T min$$

### Example 3

$$\begin{matrix}Transmit time = \begin{matrix}\frac{1 * ( T min - T max )}{4} : & if ( Ri > Rth AND Link Metric < LMth )\end{matrix} \\ = \begin{matrix}\frac{2 * ( T min - T max )}{4} : & if ( Ri > Rth AND Link Metric \geq LMth )\end{matrix} \\ = \begin{matrix}\frac{3 * ( T min - T max )}{4} : & if ( Ri \leq Rth AND Link Metric < LMth )\end{matrix} \\ = \begin{matrix}\frac{4 * ( T min - T max )}{4} : & if ( Ri \leq Rth AND Link Metric \geq LMth )\end{matrix}\end{matrix}$$

Where,
Rth—Preconfigured threshold for the Routable Index
LMth—Preconfigured threshold for the link metric

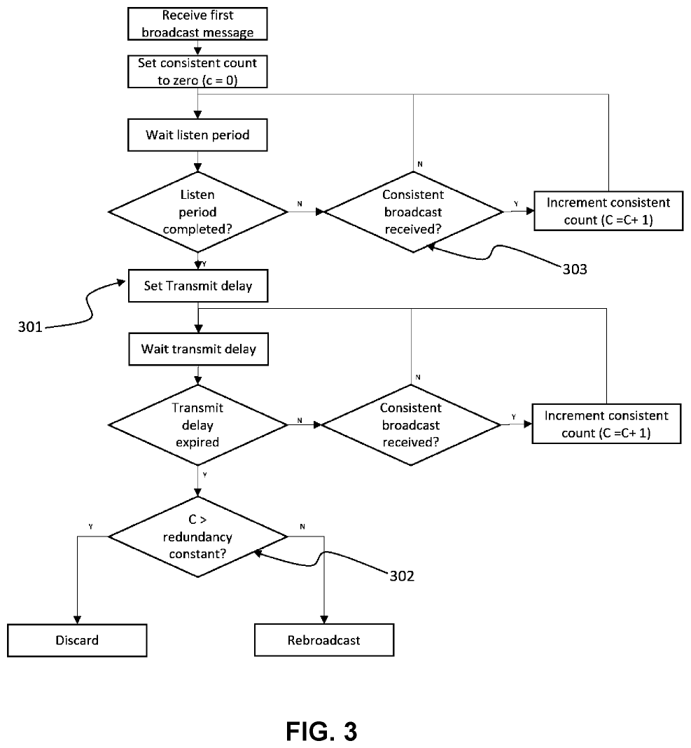

FIG. 3 is a flow diagram showing broadcast in a mesh network that utilizes routable index, in accordance with an embodiment of the present invention. The method starts with a node receiving first broadcast message, and the consistent count is set to zero (c=0). The node then waits for a listen period, and listens for consistent broadcasts. If a consistent broadcast is not received, then note waits for the listen period. If a consistent broadcast is received, it will increment consistent count to c+1 (C=c+1). After the listen period is over, the node sets the transmit delay 301. The transmit delay 301 is calculated based on the Routable index calculated for a node in unicast transmission. If the calculated routable index is high, then the transmit time will be lower as the transmit time is a function of calculated Routable index. If during the transmit delay time, another consistent broadcast is received then the consistent count is increased to 1 (C=C+1). After the transmit delay period is over, the node will determine whether the consistent count is greater than redundancy constant. Based on the determination, the node will rebroadcast the message if the consistent count is less than redundancy constant, and discard the message if the consistent count is less than redundancy constant.

The redundancy constant (302 in FIG. 3) is a threshold that determines whether or not there are enough broadcast messages in the cluster to suppress the further forward. Nodes with a higher Routable Index can use a higher redundancy constant so that they get a higher chance to get selected to forward the broadcast packet.

We claim:

1. A method to improve broadcast in a mesh network comprising:
collecting routing information about role of a node in forwarding a unicast packet;
utilizing the routing information of the node to calculate a transmit time for the node and a redundancy constant for the node in Trickle algorithm;
applying the transmit time and the redundancy constant in the Trickle algorithm to decide if and when to re-broadcast the message.

2. The method of claim 1, wherein the method further comprising calculating a routable index for the node to determine if the node has previously routed a packet from the broadcast originator.

3. The method of claim 1, wherein the method further comprising determining a link metric of the broadcast message and applying it in the Trickle algorithm to rebroadcast the message with lower link metric.

4. The method of claim 1, wherein the node having higher redundancy constant increases the probability of broadcasting the message.

5. The method of claim 1, wherein in a mesh routing system using the trickle algorithm based on a metric calculated using RSSI and SNR/LQI for retransmission of broadcast packets including an algorithm for routing unicast packets, modifying the trickle algorithm to include parameters from said unicast routing algorithm to improve probability of packets being forwarded from one network cluster to another.

6. The method of claim 1, wherein the method comprises assessing whether the node is designated as part of a constructed route for unicast packets between two other nodes.

7. The method of claim 1, wherein the redundancy constant is modified based on unicast routing information.

8. The method of claim 1, wherein the unicast routing information is comprised of at least static configuration of the node as a router.

9. The method of claim 1, wherein the unicast routing information is comprised of at least the number of times the node has forwarded unicast packets.

10. The method of claim 1, wherein the unicast routing information is comprised of at least the number of times the node has forwarded unicast packets from the broadcast originator.

11. The method of claim 1, wherein the unicast routing information is comprised of at least static configuration and the number of times the node has forwarded unicast packets from the broadcast originator.

12. The method of claim 1, wherein the decision of transmission time is also based on LQI/SNR.

13. The method of claim 1, wherein the decision of transmission time is also based on RSSI.

14. The method of claim 1, wherein the decision of transmission time is also based on LQI/SNR and RSSI.
